(19) United States
(12) Patent Application Publication
(10) Pub. No.: US 2012/0087060 A1
(43) Pub. Date: Apr. 12, 2012

(54) SUPERCAPACITOR MODULE

(75) Inventors: Senug Hyun RA, Gyeonggi-do (KR); Bae Kyun Kim, Gyeonggi-do (KR)

(73) Assignee: SAMSUNG ELECTRO-MECHANICS CO., LTD.

(21) Appl. No.: 13/073,378

(22) Filed: Mar. 28, 2011

(30) Foreign Application Priority Data
Oct. 7, 2010 (KR) 10-2010-0097758

(51) Int. Cl. H01G 9/155

(52) U.S. Cl. 361/502

(57) ABSTRACT

Disclosed herein is a supercapacitor module. The supercapacitor module includes: a plurality of supercapacitors; and a plurality of water cooling jackets having the plurality of supercapacitors inserted therebetween to be stacked and having cooling flow passages protrudedly connected to both sides thereof; wherein the supercapacitors and the cooling jackets are alternately stacked, each of fixing plates is combined with the water cooling jacket at an uppermost layer and the water cooling jacket at a bottommost layer, and the fixing plates are supported by a supporter.

### CROSS REFERENCE TO RELATED APPLICATION

This application claims the benefit under 35 U.S.C. Section 119 of Korean Patent Application Serial No. 10-2010-0097758, entitled “Supercapacitor Module” filed on Oct. 7, 2010, which is hereby incorporated by reference in its entirety into this application.

### BACKGROUND OF THE INVENTION

1. Technical Field

The present invention relates to a supercapacitor module, and more particularly, to a supercapacitor module in which capacitors and water cooling jackets are alternately stacked and fixed, thereby preventing the deformation of the capacitors while cooling the capacitors.

2. Description of the Related Art

Recently, a supercapacitor has been spotlighted as a high-quality renewable energy source capable of being applied to various fields such as an electric vehicle, a hybrid electric vehicle, a fuel cell vehicle, heavy equipment, a portable electronic device, and the like.

At this time, a supercapacitor may be classified into an electrical double layer capacitor (EDLC) using the principle of an electrical double layer and a hybrid supercapacitor using an electro-chemical oxidation-reduction reaction.

Herein, the electrical double layer capacitor has been used in various fields requiring high-output energy characteristics; however, has capacitance smaller than a secondary battery. Research into the hybrid supercapacitor as an alternative for improving capacitance characteristics of the electrical double layer capacitor has actively been conducted. In particular, among the hybrid supercapacitor, a lithium ion capacitor (LIC) has a small size; however, may have a storage capacitance of three to four times as compared to the electrical double layer capacitor.

The supercapacitor may be configured to include cathodes and anodes alternately stacked and separators inserted between the stacked cathodes and anodes to electrically separate the cathodes from anodes.

Meanwhile, the supercapacitor may have high output characteristics; however, has relatively low energy storage characteristics. Therefore, devices requiring a large storage capacitance such as vehicles and heavy equipments have used in a module form in which several supercapacitors are connected in series or in parallel.

At this time, the supercapacitor module may improve energy storage characteristics by driving a plurality of supercapacitors. However, heat generated at the time of driving the supercapacitor module is also rapidly increased, such that the reliability or the stability of the supercapacitor module may be deteriorated. Accordingly, there are limitations in the number of supercapacitors included in the supercapacitor module or the use environment of the supercapacitor module.

Therefore, a need exists for technologies for effectively discharging heat generated during driving of the plurality of supercapacitors in the supercapacitor module.

### SUMMARY OF THE INVENTION

An object of the present invention is to provide a supercapacitor module in which supercapacitors packaged in a pouch form and water cooling jackets are alternately stacked and fixed by fixing plates to have an increase storage capacitance due to the connection of a plurality of supercapacitors.

Another object of the present invention is to provide a supercapacitor module in which each of fixing plates is combined with water cooling jackets at an uppermost layer and a bottommost layer in the state in which a plurality of supercapacitors and a plurality of water cooling jackets are alternately stacked to perform modulization, such that each of the supercapacitors is compressed while cooling the supercapacitors, thereby preventing deformation of the supercapacitor.

According to an exemplary embodiment of the present invention, there is provided a supercapacitor module, including: a plurality of supercapacitors; and a plurality of water cooling jackets having the plurality of supercapacitors inserted therebetween to be stacked and having cooling flow passages protrudedly connected to both sides thereof; wherein the supercapacitors and the cooling jackets are alternately stacked, each of fixing plates is combined with the water cooling jacket at an uppermost layer and the water cooling jacket at a bottommost layer, and the fixing plates are supported by a supporter.

The supercapacitor stacked between the water cooling jackets may be packaged in a pouch form in which a pair of laminate films is heat fused on an upper portion and a lower portion thereof.

The water cooling jacket may be made of a metal material of aluminum or copper having high thermal conductivity, the cooling flow passage may be connected to a channel formed within a body of the water cooling jacket and may be connected with another cooling flow passage protruded from each of the water cooling jackets, thereby making it possible to circulate cooling water.

Each of the water cooling jackets disposed at the uppermost layer and the bottommost layer may be provided with a cooling water inlet into which the cooling water flows and a cooling water outlet discharging the circulated cooling water to the outside in the state in which the supercapacitors and the water cooling jackets are stacked.

Each of the fixing plates may be combined with an upper surface of the water cooling jacket disposed at the uppermost layer and a lower surface of the water cooling jacket disposed at the bottommost layer and the supporter may be coupled to each edge of the fixing plates, while penetrating through the fixing plates, and each of fixing members may be coupled to each end of the supporter to adjust the compression degree of the fixing plates.

### BRIEF DESCRIPTION OF THE DRAWINGS

FIG. 1 is an exploded perspective view of a supercapacitor applied to a supercapacitor module according to an exemplary embodiment of the present invention;

FIG. 2 is a perspective view of a supercapacitor applied to a supercapacitor module according to an exemplary embodiment of the present invention;

FIG. 3 is a cross sectional view of FIG. 2;

FIG. 4 is a front view of a supercapacitor module according to an exemplary embodiment of the present invention; and

FIG. 5 is a side view of a supercapacitor module according to an exemplary embodiment of the present invention.

### DESCRIPTION OF THE PREFERRED EMBODIMENTS

The acting effects and technical configuration with respect to the objects of a supercapacitor module according to the present invention will be clearly understood by the following description in which exemplary embodiments of the present invention are described with reference to the accompanying drawings.

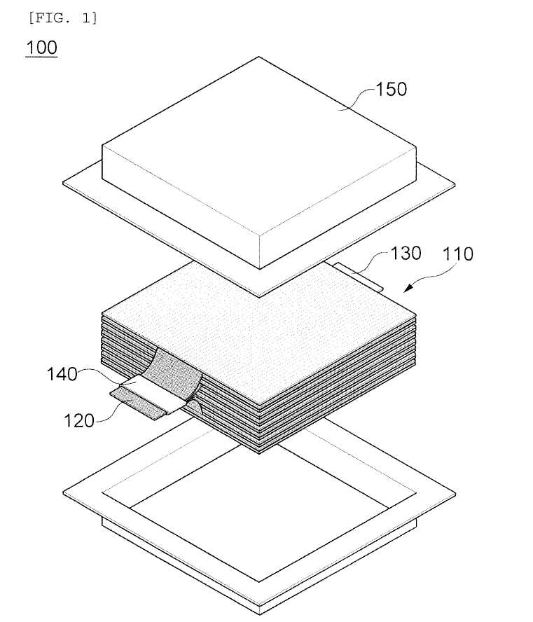

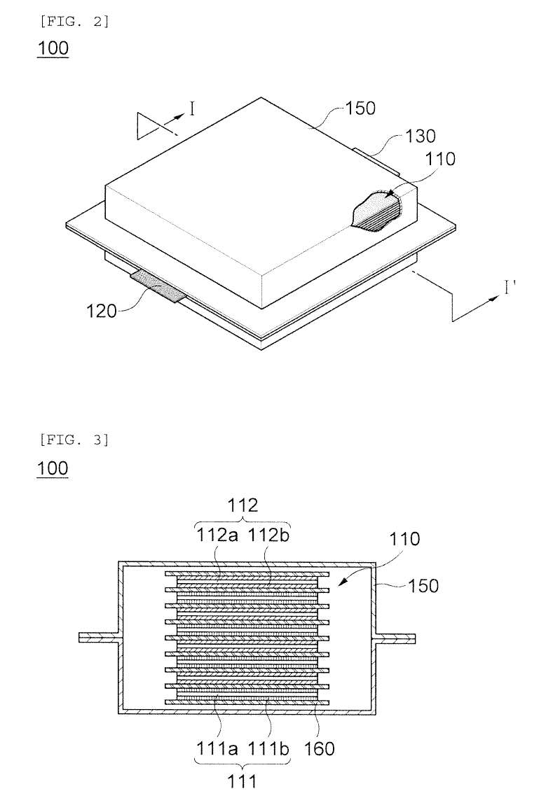

FIG. 1 is an exploded perspective view of a supercapacitor applied to a supercapacitor module according to an exemplary embodiment of the present invention, FIG. 2 is a perspective view of a supercapacitor applied to a supercapacitor module according to an exemplary embodiment of the present invention, and FIG. 3 is a cross sectional view of FIG. 2.

As shown in FIGS. 1 to 3, a supercapacitor 100 applied to a supercapacitor module according to the present embodiment may be configured to include a plurality of electrode cells 110, an electrolyte solution, and a housing 150.

Herein, the electrode cell 110 may include first and second electrodes 111 and 112 alternately stacked, having a separator 160 therebetween. The separator 160 may electrically separate the first electrode 112 from the second electrode 112. The separator 160 may be a paper or a woven fabric. However, in the exemplary embodiment of the present invention, the sort of the separator 150 is not limited thereto.

The first electrode 111 may include a first current collector 111a and a first active material layer 111b each disposed on both sides of the first current collector 111a. At this time, the first electrode 111 may be a cathode, and the first current collector 111a may be made of any one of aluminum, stainless steel, copper, nickel, titanium, tantalum, and niobium.

The first current collector 111a may have a thin film form; however, may also include a plurality of through-holes in order to effectively perform the movement of ions and a uniform doping process.

In addition, the first active material layer 111b disposed on both surfaces of the first current collector 111a may include a carbon material capable of reversibly doping and dedoping the ions, that is, activated charcoal, and may further include a binder.

In addition, the first active material layer 111b may be made of a conductive material further including a carbon black, a solvent, and the like.

The second electrode 112 may include a second current collector 112a and a second active material layers 112b each disposed on both sides of the second current collector 112a.

For example, the second electrode may be an anode, and the second current collector 112a may include any one metal material of copper, nickel and stainless steel, similar to the first current collector 111a. The second current collector 112a may have a thin film form; however, may also include a plurality of through-holes in order to effectively perform the movement of ions and a uniform doping process.

In addition, the second active material layer 112b may include a carbon material capable of reversibly doping and dedoping lithium ions, i.e., graphite or activated charcoal. Herein, when an electrochemical capacitor is a lithium ion capacitor, the second active material layer 112b may be graphite with which lithium ions are pre-doped.

Accordingly, the potential of the second electrode 112 may be lowered to be close to the potential of lithium, that is, 0V, thereby making it possible to increase the energy density of the lithium ion capacitor. At this time, the potential of the second electrode 112 may be adjusted by controlling a pre-doping process of the lithium ions.

In addition, the first electrode 111 may further include a first terminal 120 connected to an external power supply. The first terminal 120 may be extended from one side of the first current collector 111a.

When a plurality of first electrodes 111 are stacked within the electrode cell 110, a plurality of first terminals 120 extended from each of the first electrodes 111 may also be stacked. At this time, the stacked first terminals 120 may be fused to be integrally formed with each other in order to be connected to the outside.

The fused first terminals 120 may be connected directly to the external power supply, or may be fused to an external terminal to be connected to the external power supply through the external terminal.

In addition, the first electrode 112 may include a second terminal 130 connected to the external power supply. At this time, the second terminal 130 may be extended from one side of the second current collector 112a. Herein, a plurality of second terminals 130 may be fused to be integrally formed with each other. At this time, the fused second terminals 130 may be connected directly to the external power supply, or may be fused to the external terminal to be connected to the external power supply through the external terminal.

Additionally, upper portions and lower portions of the first and second terminals 120 and 130 or the external terminal may be provided with an insulating member 140. The insulating member 140 may insulate the first and second terminals 120 and 130 or the external terminal from the housing 150 described below.

Herein, the electrolyte solution is impregnated into the electrode cell 110. In some cases, it may be impregnated into the first and second active material layers 111b and 112b and the separator 160.

Although a pouch type of the electrode cell 110 has been shown and described in the exemplary embodiment of the present invention, a winding type of electrode cell 110 in which the first and second electrodes 111 and 112 and the separator are wound in a roll form may also be used.

The housing 150 is formed by heat fusing two sheets of metal laminate films, such that a plurality of electrode cells may be packaged in a pouch form therein.

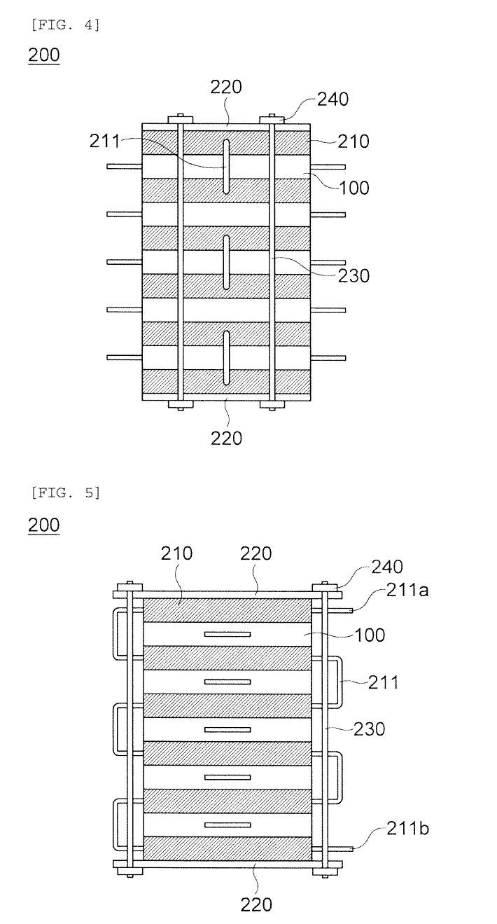

A configuration of a large capacitance module using a supercapacitor packaged in the pouch form will be described in detail with reference to FIGS. 4 and 5.

FIG. 4 is a front view of a supercapacitor module according to an exemplary embodiment of the present invention, and FIG. 5 is a side view of a supercapacitor module according to an exemplary embodiment of the present invention.

As shown in FIGS. 4 and 5, a supercapacitor module 200 according to an exemplary embodiment of the present invention may have a plurality of supercapacitors 100 and a plurality of water cooling jackets 210 alternately stacked therein. At this time, the plurality of supercapacitors 100 may be configured of a supercapacitor packaged in a pouch form in which a pair of laminate films is heat fused on an upper portion and a lower portion thereof.

The water cooling jackets 210 may be configured in the same form as the supercapacitors, and are, preferably, formed to have a body having the same size and height as the supercapacitors 100 so that when the water cooling jackets and the supercapacitors 100 are alternately stacked, front surfaces of the supercapacitors 100 contact with the water cooling jackets 210 to improve cooling efficiency.

In addition, the water cooling jacket 210 may include a channel (not shown) through which cooling water or a refrigerant flows within the body, and cool the heat generated from the supercapacitors 100 contacting with an upper portion and a lower portion of the water cooling jackets 210 by the flow of the cooling water or the refrigerant.

At this time, the water cooling jacket 210 may be made of a metal material an excellent thermal conductivity, and preferably, aluminum, copper, or the like, having a high thermal conductivity. However, in the exemplary embodiment of the present invention, the material of the water cooling jacket 210 is not limited.

Meanwhile, a cooling flow passage 211 may be connected to both sides of the water cooling jacket 210 so that the cooling water capable of flowing within the body may be circulated through the plurality of water cooling jackets 210. The cooling flow passage 211 may be protruded to the outside of the water cooling jacket 210, while being connected to the channel formed within the body. The cooling flow passages 211 protruded from the water cooling jackets 210 positioned on the upper portion and the lower portion of the supercapacitors 100 may be interconnected.

The water cooling jackets 210 as described above are stacked together with the plurality of supercapacitors 100 to be positioned between each of the supercapacitors, on an upper surface of the uppermost supercapacitor 100 and on a lower surface of the bottommost supercapacitor 100, such that each of the water cooling jackets contacts with an upper surface and a lower surface of each of the supercapacitors 100. Therefore, the water cooling jackets effectively radiate the heat generated from the upper surfaces and the lower surfaces of the supercapacitors 100, thereby making it possible to secure reliability and security for heat generation in the supercapacitors 100.

In addition, each of the water cooling jacket 210 stacked at the uppermost layer and the water cooling jacket 210 stacked at the bottommost layer may be provided with a cooling water inlet 211a and a cooling water outlet 211b, wherein the cooling water inter 211a is supplied with the cooling water from the outside to inject the cooling water into the body and the cooling water outlet 211b discharges the cooling water circulated through the water cooling jackets 210.

Meanwhile, in the state in which the plurality of supercapacitors 100 and the water cooling jackets 210 are alternately stacked, each of fixing plates 220 is combined with the outside of each of the water cooling jackets 210 at the uppermost and bottommost layers, and may be fixed by a supporter 230 coupling the water cooling jacket 210 at the uppermost layer to the water cooling jacket 210 at the bottommost layer.

In the state in which the supercapacitors 100 and the water cooling jackets 210 are alternately stacked the fixing plates 220 may compress the water cooling jackets 210 at the uppermost and bottommost layers through the supporter 230. Accordingly, each of the upper and lower surfaces of the supercapacitors 100 stacked between the water cooling jackets 100 are compressed to one surface of the water cooling jacket 210. Therefore, even though the heat is spontaneously generated within the supercapacitors 100 during charging of the supercapacitors 100, thermal deformation of the supercapacitors packaged in the pouch form is prevented, thereby making it possible to prevent the equivalent series resistance (ESR) of the supercapacitors from being increased.

A fixing member 240 such as a bolt, a nut, or the like, may be coupled to an upper end and a lower end of the supporter 230 coupled to the fixing plate 200. At this time, the compression degree of the fixing plate 220 coupled to the supporter 230 may be adjusted through the fixing member 240.

In the supercapacitor module 200 configured as described above, the supercapacitors 100 having the cathode and the anode protruded to both sides thereof are disposed between the water cooling jackets 210 having the cooling flow passage 211 protruded to both sides thereof, and each of the fixing plates 220 is combined with the upper surface of the water cooling jacket 210 at the uppermost layer and the lower surface of the water cooling jacket 210 at the bottommost layer, such that the water cooling jackets compress the upper and lower portions of the supercapacitors 100, thereby making it possible to prevent deformation of the supercapacitors 100. In addition, the water cooling jackets 210 through which the cooling water is circulated are closely attached with both sides of the supercapacitors, thereby making it possible to radiate the heat generated from the supercapacitors.

The supercapacitor module according to the exemplary embodiments of the present invention may configure a large capacitance charging module by sequentially stacking a plurality of supercapacitors. Therefore, the supercapacitor module disposes water cooling jackets on an upper portion and a lower portion of the supercapacitor to be closely attached with the supercapacitor to discharge the heat generated during charging of the supercapacitor, thereby making it possible to minimize thermal deformation of the supercapacitor. In addition, the alternately stacked water cooling jacket and supercapacitor are combined while being compressed by the fixing plate, thereby making it possible to basically prevent deformation such as expansion of the pouch of the supercapacitor packaged in the pouch form, and the like.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A supercapacitor module, comprising:
a plurality of supercapacitors; and
a plurality of water cooling jackets having the plurality of supercapacitors inserted therebetween to be stacked and having cooling flow passages protrudedly connected to both sides thereof;
wherein the supercapacitors and the cooling jackets are alternately stacked, each of fixing plates is combined with the water cooling jacket at an uppermost layer and the water cooling jacket at a bottommost layer, and the fixing plates are supported by a supporter.

2. The supercapacitor module according to claim 1, wherein the supercapacitor is packaged in a pouch form in which a pair of laminate films is heat fused on an upper portion and a lower portion thereof.

3. The supercapacitor module according to claim 1, wherein the water cooling jacket is made of a metal material of aluminum or copper having high thermal conductivity.

4. The supercapacitor module according to claim 1, wherein the cooling flow passage is connected to a channel formed within a body of the water cooling jacket, and is connected with another cooling flow passage protruded from each of the water cooling jackets.

5. The supercapacitor module according to claim 1, wherein each of the water cooling jackets disposed at the uppermost layer and the bottommost layer is provided with a cooling water inlet and a cooling water outlet in the state in which the supercapacitors and the water cooling jackets are stacked.

6. The supercapacitor module according to claim 1, wherein each of the fixing plates is combined with an upper surface of the water cooling jacket disposed at the uppermost layer and a lower surface of the water cooling jacket disposed at the bottommost layer, and the supporter is coupled to each edge of the fixing plates, while penetrating through the fixing plates.

7. The supercapacitor module according to claim 6, wherein each of fixing members is coupled to each end of the supporter to adjust the compression degree of the fixing plates.
